(19) United States
(12) Patent Application Publication
(10) Pub. No.: US 2007/0003260 A1
(43) Pub. Date: Jan. 4, 2007

(54) Heater for vacuum cleaners

(76) Inventor: Carlisle Thweatt JR., South Haven, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/449,137

(22) Filed: Jun. 8, 2006

Related U.S. Application Data
(63) Continuation of application No. 11/204,871, filed on Aug. 16, 2005, now Pat. No. 7,065,293.
Application No. 11/204,871 is a continuation of application No. 10/752,059, filed on Jan. 6, 2004, now Pat. No. 6,941,064.
Application No. 10/752,059 is a continuation-in-part of application No. 09/827,232, filed on Apr. 5, 2001, now Pat. No. 6,873,793.
(63) Continuation-in-part of application No. 11/048,187, filed on Feb. 1, 2005, now Pat. No. 7,065,292.
Application No. 11/048,187 is a continuation of application No. 09/827,232, filed on Apr. 5, 2001, now Pat. No. 6,873,793.

(51) Int. Cl. F24H 1/10; H05B 3/78

(52) U.S. Cl. 392/488

(57) ABSTRACT

A heater for fluids includes a housing made of a non-metallic material and having an internal cavity. The housing has an inlet and an outlet, each of which are in fluid communication with the internal cavity. An elongated electrical heating element is disposed within the cavity for heating fluid flowing through the cavity. The heating element has a generally circular cross-sectional shape and has a U-shaped portion disposed in the cavity. The electrical heating element has electrical connectors at opposite ends extending through the housing, and a titanium outer surface.

### CROSS-REFERENCE TO RELATED APPLICATIONS

The present application is a continuation of U.S. patent application Ser. No. 11/204,871, filed Aug. 16, 2005, which is a continuation of U.S. Pat. No. 6,941,064, which is a continuation-in-part of U.S. Pat. No. 6,873,793, the entire contents of each of which are incorporated by reference.

This application is also a continuation-in-part of U.S. patent application Ser. No. 11/048,187, filed Feb. 1, 2005, which is a continuation of U.S. Pat. No. 6,873,793, the entire contents of each of which are incorporated by reference.

### BACKGROUND OF THE INVENTION

Various vacuum cleaners have been developed that include a reservoir that holds cleaning fluid. The cleaning fluid is heated and deposited on the floor surface to be cleaned where it contacts a rotating brush of the vacuum cleaner. The cleaning fluid, dirt, and other material is then vacuumed from the floor surface. Heaters used for such vacuum cleaners are exposed to a harsh environment due to the caustic nature of the cleaning solution that flows through the heater, such that the heating elements may corrode or otherwise degrade. Also, such heaters are prone to lime buildup on the heating element that may reduce the effectiveness of the heater.

### SUMMARY OF THE INVENTION

One aspect of the present invention is a heater for fluids including a housing made of a non-metallic material and having an internal cavity. The housing has an inlet and an outlet, each of which are in fluid communication with the internal cavity. An elongated electrical heating element is disposed within the cavity for heating fluid flowing through the cavity. The heating element has a generally circular cross-sectional shape and has a U-shaped portion disposed in the cavity. The electrical heating element has a titanium outer surface and includes electrical connectors at opposite ends extending through the housing.

Another aspect of the present invention is a heater for fluids including a housing made of a non-metallic material and defining a sidewall and an internal cavity and an opening through the sidewall. An elongated electrical heating element is disposed in the internal cavity, and has opposite ends extending through the sidewall. A metallic member is disposed at the opening in the housing, and has an inner surface exposed to the internal cavity. A temperature sensor is operably coupled to the metallic member to determine the temperature of the metallic member.

Yet another aspect of the present invention is a vacuum cleaner including a frame, a powered rotating brush, a suction unit, and a fluid container for liquid cleaning solution. A fluid conduit is provided for transport of liquid cleaning solution from the fluid container to an area adjacent the rotating brush. The vacuum cleaner further includes a heater operably connected to the fluid conduit for heating fluid flowing therethrough. The heater includes a housing defining an internal cavity and a heating element is disposed within the internal cavity of the housing. The heating element includes a titanium outer surface that contacts liquid cleaning solution in the housing.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially schematic view of a vacuum cleaner including a reservoir for liquid cleaning solution and a heater according to one aspect of the present invention;

FIG. 2 is an exploded perspective view of the heater of FIG. 1;

FIG. 3 is a perspective view of the heater in an assembled condition;

FIG. 4 is a cross-sectional view of the heater;

FIG. 5 is a partially schematic front elevational view of an electrical heater according to another aspect of the present invention;

FIG. 6 is a partially fragmentary, top view of the electrical heater of FIG. 5;

FIG. 7 is a right elevational view of the heater of FIG. 5; and

FIG. 8 is a cross-sectional view of the heating element of FIG. 6, taken along the line VIII-VIII; FIG. 6.

### DETAILED DESCRIPTION OF PREFERRED EMBODIMENT

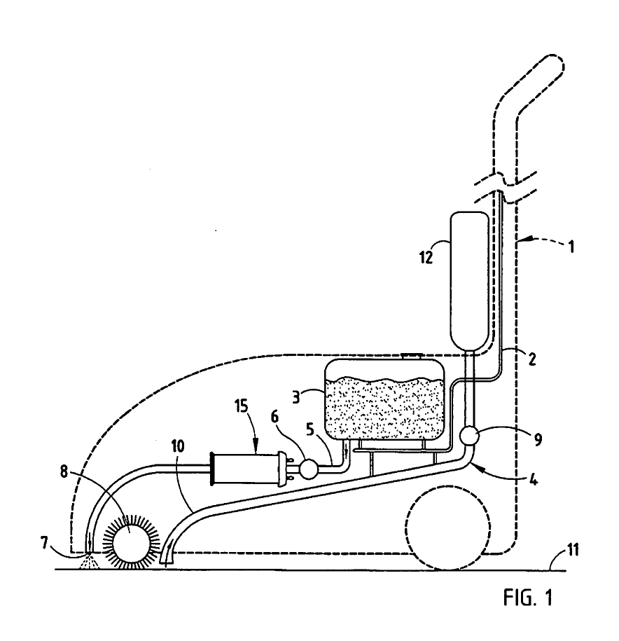

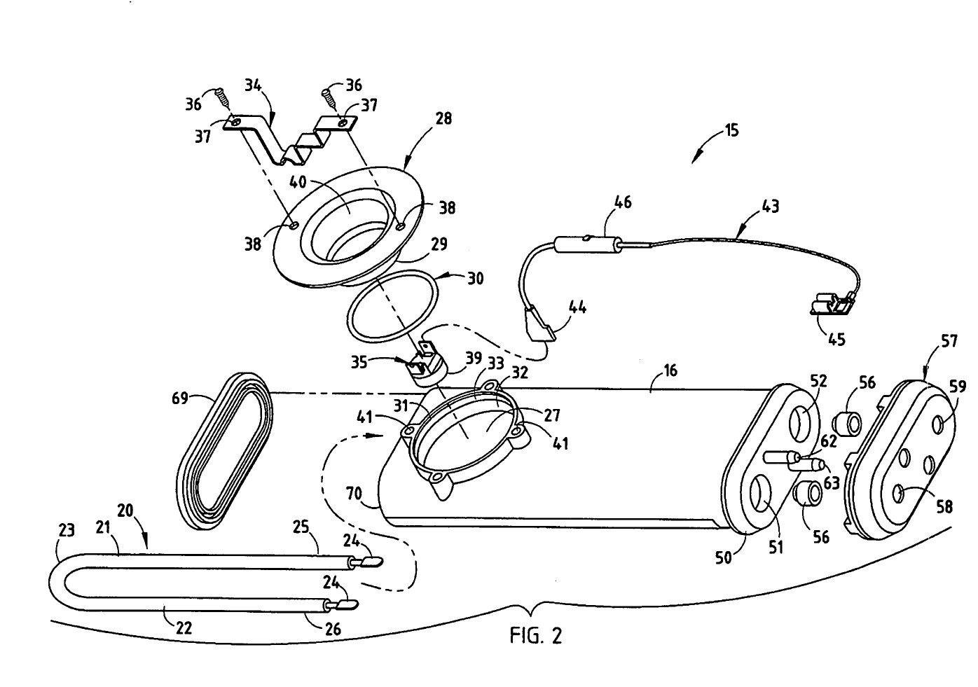

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a vacuum cleaner 1 generally includes a frame 2, a fluid reservoir 3, and a vacuum system 4. A fluid conduit assembly 5 includes a pump 6 that deposits fluid 7 from the reservoir 3 adjacent a powered rotating brush 8. A pump 9 generates a vacuum in conduit 10 to pull the fluid 7, dirt, and other debris from the floor surface 11 and into a storage container or bag 12. The frame 2, fluid reservoir 3, conduit assembly 5, and vacuum system 4 may be of various known designs, and will therefore not be described in more detail herein.

A heater 15 according to one aspect of the present invention may be utilized to heat the cleaning fluid before the fluid is deposited adjacent the powered brush 8. With further reference to FIG. 2, the heater 15 includes a housing 16 that is made of a polymer material.

The housing has a generally oval cross-sectional shape defining sidewalls 17 and 18 (see also FIG. 4). An electrical heating element 20 is generally U-shaped including elongated parallel portions 21 and 22, a curved portion 23, and includes electrical connectors 24 at the opposite ends 25 and 26 of heating element 20. The heating element 20 preferably has a titanium outer sheath, a titanium inner sheath, a dielectric powder material, and an inner heating wire substantially as described in the above-identified U.S. patent application Ser. No. 09/827,232, entitled ELECTRIC WATER HEATER.

A cup-shaped metal member 28 includes an end portion 29 that is received in opening 27 of housing 16 when assembled. A ring-like gasket 30 is made of a high temperature silicone rubber material, and provides a watertight seal between the cup-shaped metal member 28 and the housing 16. Opening 27 is defined by an outer cylindrical surface 31 and inner cylindrical surface 32. The inner cylindrical surface 32 has a diameter that is less than that of the outer cylindrical surface 31, and a tapered step 33 extends between the outer cylindrical surface 31 and the inner cylindrical surface 32. The tapered step 33 has a frusto-conical shape. When the cup-shaped metal member 28 is assembled to the housing 16, the gasket 30 is compressed against the tapered step 33, thereby deforming the gasket 30 and wedging it into tight contact with the cup-shaped metal member 28 and surfaces 31, 32 and 33 of housing 16. The metallic member 28 may be made of anodized aluminum or other suitable material having sufficient heat-transfer and corrosion resistance properties.

A thermostat 35 has an end 39 that is held in contact with inner surface 40 of metal member 28 by a clip 34. When assembled, screws 36 extend through openings 37 in clip 34, openings 38 in metal member 28, and into openings 41 in housing 16 to thereby retain the end 39 of thermostat 35 in contact with inner surface 40 of metal member 28. The screws 36 also compress the gasket 30 to provide a watertight seal between the metal member 28 and housing 16. Because the metal member 28 readily conducts heat, the end 39 of thermostat 35 is kept at substantially the same temperature as fluid flowing within the housing 16. In this way, the thermostat 35 is protected from the potentially caustic fluid, yet is still maintained at substantially the same temperature as the fluid in the housing 16. A thermal cutout assembly 43 includes an electrical connector 44 that connects to the thermostat 35, and a second electrical connector 45 that connects to an electrical connector 24 of heating element 20. The thermal cutout assembly 43 includes a thermal cutout 46 that shuts off the heater element 20 when the temperature of the thermostat 35 is at or above a preselected temperature. The thermal cutout 46 thereby prevents overheating of the heating element 20 and associated components if fluid flow through the heater 15 is stopped, or if the fluid otherwise reaches too high of a temperature. The thermal cutout 46 and related electrical components are of a known design, such that these components will not be described in detail herein.

Housing 16 has a first end 50 having a first opening 51 and a second opening 52, each of which include an outer cylindrical surface 53, tapered step 54 and inner cylindrical surface 55. When assembled, the end portions 25 and 26 of heating element 20 extend through openings 51 and 52, and ring-like silicone rubber gaskets 56 fit tightly against the surfaces 53, 54 and 55 to thereby provide a waterproof seal. A cover 57 includes first and second openings 58 and 59 through which the ends 25 and 26 extend, and the cover 57 includes connectors 60 that extend around lip 61 of housing 16 to thereby tightly retain the cover 57 on the housing 16.

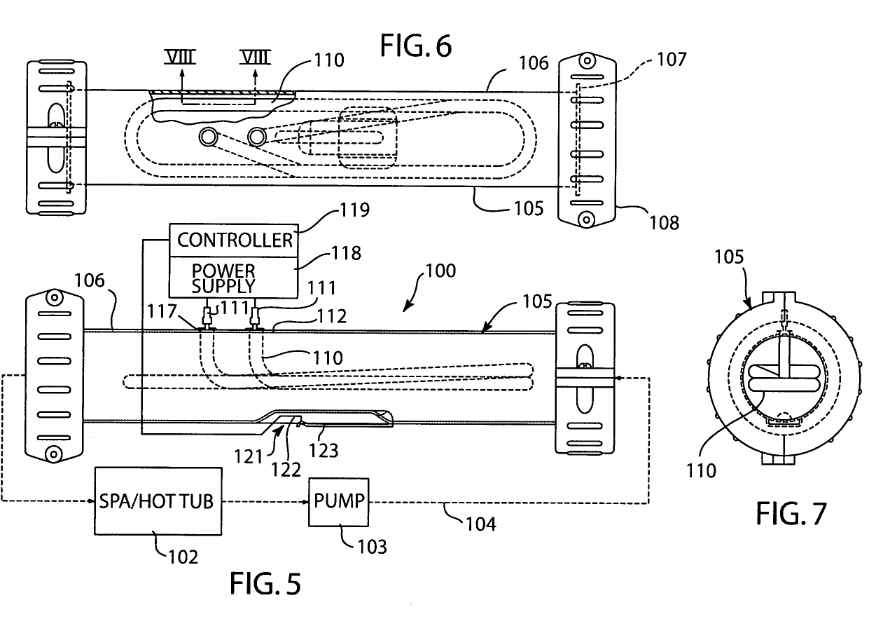

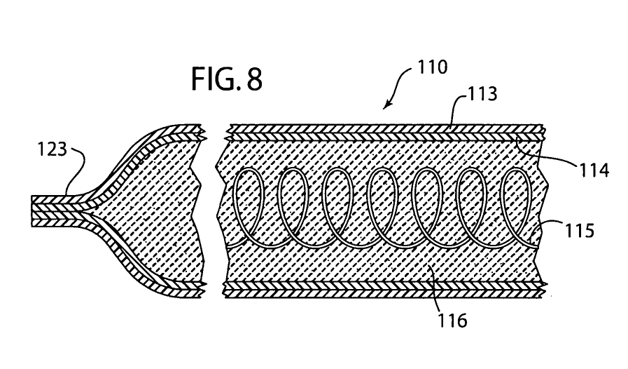

With reference to FIG. 5, a spa system 101 according to the present invention includes a pool/spa/hot tub 102, an electrical pump 103, an electrical heater 105, and tubing 104 interconnecting the components of the spa system to provide circulation of water therethrough. The electrical heater 105 includes a titanium tubular housing 106 having an outer diameter in the range of about 1-1/2 inches to 3 inches. In the illustrated example, tubular housing 106 has an outer diameter of 2.25 inches. Tubular housing 106 includes flanges 107 at opposite ends thereof to retain couplers 8 for connection to the tubing 104 or other spa components. An elongated electrical heating element 110 includes electrical connectors 111 that extend through a wall portion 112 of tubular housing 106. With further reference to FIG. 8, electrical heating element 110 has an outer sheath 113 made of a titanium material, and an inner sheath 114 made of a stainless steel material. An electrical resistance line 115 is made of a material such as nickel chromium, or the like, and is disposed within the inner sheath 114 and connected to the electrical connectors 111 at opposite ends thereof. The electrical heating element 110 includes a dielectric material such as magnesium oxide powder 116 disposed within the inner sheath 114 around the electrical resistance line 115 to facilitate heat transfer from the electrical resistance line 115 to the inner sheath 114, outer sheath 113, and the water flowing through the housing 106.

Electrical connectors 111 (FIG. 5) extend through flared openings 117 in tubular housing 106. Because the outer sheath 113 of electrical heating element 110 is made of a titanium material, the electrical heating element 110 can be welded at the flared openings 117 of housing 106, thereby providing a durable leakproof connection. The electrical connectors 111 are operably connected to a power supply 118 that receives signals from a connector 119. Housing 106 includes an indented portion 121 that receives a temperature sensor 120. The temperature sensor 120 is retained in the indentation 121 against the housing 106 by a flexible metal cover 122 that is tack welded to housing 106. The temperature sensor 120 is in contact with the housing 106, such that the temperature of the water flowing through the housing 106 can be sensed. Temperature sensor 120 is operatively connected to controller 119, and the controller 119 is programmed to control the electric heating element in a known manner. An example of one such arrangement is disclosed in U.S. Pat. No. 6,080,973 entitled “ELECTRIC WATER HEATER” filed on Apr. 19, 1999, the entire contents of which is hereby incorporated by reference.

With further reference to FIG. 8, the stainless steel inner sheath 114 is first fabricated with the electrical resistance wire 115 and dielectric material 116 disposed therein according to known methods. The titanium outer sheath or sleeve 113 is then placed over the stainless steel inner sheath 114 and roll reduced in a standard rolling mill to provide a tight fit resulting in a high rate of heat transfer between the inner sheath 114 and outer sheath 113. Prior to roll reduction, the end 123 of sheaths 113 and 114 is tightly crimped to eliminate relative motion between the sheaths 113 and 114 to ensure proper roll reduction. The roll reduction and tight fit of the outer sheath 113 causes the outer sheath 113 to experience hoop stress, thus ensuring that contact is maintained between the outer sheath 113 and inner sheath 114. The magnesium oxide or other powder 116 is tightly compacted to provide heat transfer from the electrical resistance heater line 115 to the inner sheath 114. Although the titanium outer sheath 113 will stress relief slightly at higher temperatures, such as 1000° F., the stainless steel inner sheath 114 will not stress relief in this manner, thereby maintaining the compaction of the dielectric material 116 and proper heat transfer. In a preferred example, stainless inner sheath 114 has a thickness of 0.020 inches, and outer titanium sheath 113 has a thickness of 0.035 inches. The inner sheath 114 and outer sheath 113 may have thicknesses in the range of about 0.015-0.050 inches.

Thus, the electric heating element 110 is very corrosion resistant, yet maintains proper heat transfer through the dielectric material 116. Furthermore, because the outer sheath 113 is made of a titanium material, the electric heating element 110 can be welded to the titanium housing 106, thus providing a secure, leakproof connection.

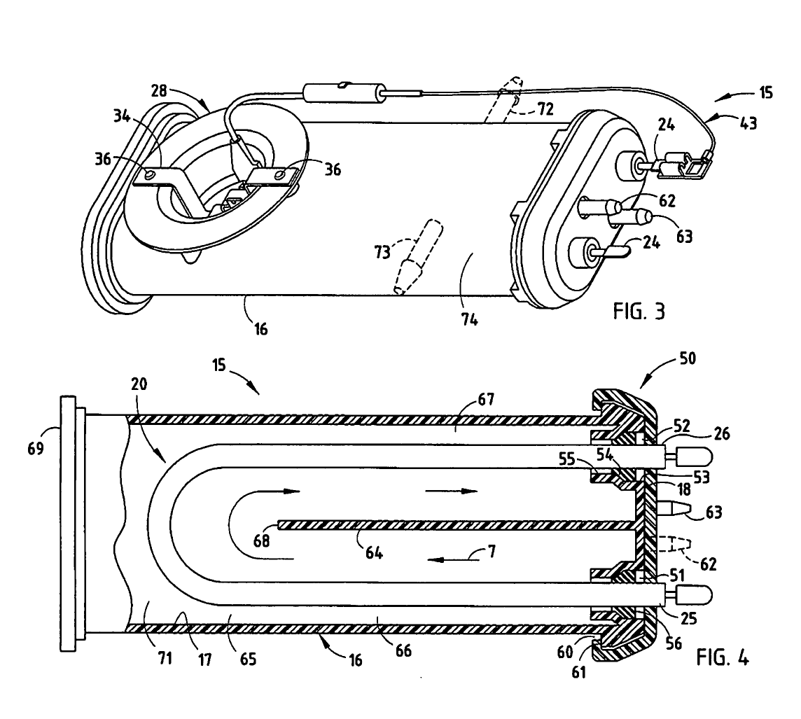

A pair of barbed fluid connectors 62 and 63 may be formed at the first end 50 of housing 16. With reference to FIG. 4, housing 16 includes a divider wall 64 that forms a generally U-shaped internal cavity 65 having generally parallel first and second portions 66 and 67. A polymer cover 69 closes off the open second end 70 of housing 16, and may be welded thereto. End 68 of divider wall 64 is spaced apart from cover 69 to form a gap 71 interconnecting the first and second portions 66 and 67 of internal cavity 65. This arrangement causes the fluid 7 in housing 16 to flow in a generally U-shaped pattern, such that the fluid 7 is heated by the heating element. As illustrated in FIG. 3, barbed fluid connectors 72 and 73 may alternately be positioned at an end sidewall portion 74 of housing 16.

The heater of the present invention may be fabricated in a very cost-effective manner, and the titanium heating element alleviates lime buildup and other problems associated with known heaters. Furthermore, the cup-shaped metal member and thermostat provide for accurate determination of the temperature of the fluid in the housing, despite the fact that the housing does not readily transfer heat. Still further, the silicone rubber fitting arrangements provide for a very secure watertight interconnection where the various components extend through the housing sidewalls. The silicone rubber accommodates differences in thermal expansion between the various components, such that a watertight seal is maintained across a range of operating conditions and temperatures.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An electrical heater for fluid, comprising:
a housing having a wall portion with at least one opening therethrough;
an elongated electrical heating element having electrical connectors on opposite ends thereof extending through the opening in the wall portion, the electrical heating element having an outer layer made of a titanium material, and an inner layer made of a stainless steel material, the titanium outer layer being tightly fitted around the stainless steel inner layer, the electrical heating element having an electrical resistance line disposed within the inner layer and connected to the electrical connectors at opposite ends thereof, the electrical heating element including a dielectric material disposed within the inner layer around the electrical resistance line to facilitate heat transfer from the electrical resistance line to the inner layer.

2. The electrical heater set forth in claim 1, wherein:
the housing is generally tubular with a curved sidewall portion, and the opening is in the curved sidewall portion.

3. The electrical heater of claim 1, wherein:
the wall portion of the housing is made of a polymer material.

4. The electrical heater of claim 1, wherein:
the at least one opening comprises first and second openings, and a first end of the electrical heating element extends through the first opening and a second end of the electrical heating element extends through the second opening.

5. The electrical heater of claim 4, including:
first and second ring-like sealing members in tight contact with the first and second ends, respectively, and providing a fluid-tight seal.

6. The electrical heater of claim 1, wherein:
the housing includes at least one end having a generally flat sidewall portion, and wherein the at least one opening is in the flat sidewall portion.

7. The electrical heater of claim 6, including:
a cover member connected to the housing and extending over at least a substantial portion of the flat sidewall portion.

8. The electrical heater of claim 1, wherein:
the housing is made of a titanium material.

9. The electrical heater of claim 1, wherein:
the housing has a metal sidewall portion; and including:
a temperature sensor mounted to an outside of the housing to measure the temperature of the metal sidewall portion.

10. An electrical heater, comprising:
a tubular housing having a wall portion defining a cavity;
a heating element having an outer sheath made of a titanium material, and an inner sheath made of a stainless steel material, the titanium outer sheath being tightly fitted around the stainless steel inner sheath, the electrical heating element having an electrical resistance line disposed within the inner sheath, the electrical resistance line defining opposite ends, the electrical heating element including a dielectric powder disposed within the inner sheath around the electrical resistance line, the outer sheath and the inner sheath compressing the dielectric powder around the electrical resistance line, the electrical heating element having a curved portion disposed in the cavity and having a curved portion that is generally U-shaped, and wherein opposite ends of the electrical resistance line extend through the wall portion of the housing.

11. The electrical heater set forth in claim 10, wherein:
the electrical resistance line is made of a metal material.

12. The electrical heater set forth in claim 10, wherein:
the outer sheath has a wall thickness in the range of about 0.015 inches to 0.050 inches.

13. The electrical heater set forth in claim 12, wherein:
the inner sheath has a wall thickness in the range of about 0.015 inches to 0.050 inches.

14. A method of fabricating an electrical heating element, the method comprising:
providing an electrical resistance heating line;
placing the electrical resistance heating line in a stainless steel sheath;
positioning dielectric powder around the electrical resistance heating line;
placing a titanium sheath over the stainless steel sheath; and
simultaneously compacting the titanium and stainless steel sheaths to compress the dielectric powder around the heating line wherein at least one of the titanium sheath and the stainless steel sheath are fixed relative to one another prior to compaction to substantially prevent movement of the titanium sheath relative to the stainless steel sheath during compaction of the titanium and stainless steel sheaths.

15. The method set forth in claim 14, wherein:
the titanium and stainless steel sheaths are compacted by rolling.

16. The method set forth in claim 15, wherein:
the sheaths are compressed sufficiently to maintain compaction of the dielectric magnesium powder when the electrical heating element reaches a temperature of at least about one thousand degrees Fahrenheit.

17. The method set forth in claim 16, wherein:
the dielectric powder comprises magnesium.

18. The method set forth in claim 15, wherein:
the inner and outer sheaths each have a generally circular cross sectional shape, the inner surface of the outer sheath tightly contacting the outer surface of the inner sheath.
